(19) United States
(12) Patent Application Publication
(10) Pub. No.: US 2013/0240642 A1
(43) Pub. Date: Sep. 19, 2013

(54) MAGNETIC ACTUATOR, VALVE AS WELL AS USE OF A MATERIAL IN MAGNETIC ACTUATORS

(71) Applicants: Anna Salvat MASSONI, Ludwigsburg (DE); Joerg ABEL, Gerlingen (DE)

(72) Inventors: Anna Salvat MASSONI, Ludwigsburg (DE); Joerg ABEL, Gerlingen (DE)

(73) Assignee: Robert Bosch GmbH, Stuttgart (DE)

(21) Appl. No.: 13/800,235

(22) Filed: Mar. 13, 2013

(30) Foreign Application Priority Data
Mar. 19, 2012 (DE) 10 2012 204 299.7

(51) Int. Cl. H02K 1/02; F02M 51/06

(52) U.S. Cl. CPC H02K 1/02; F02M 51/0614
USPC 239/585.1; 310/14

(57) ABSTRACT

A magnetic actuator includes: a coil, an internal pole, an armature, and a magnetic return path system having a magnetic return path element made from a material having a two-phase structure.

### BACKGROUND OF THE INVENTION

1. Field of the Invention

The present invention relates to a magnetic actuator, a valve for injecting fuel or controlling a valve member, including the magnetic actuator, as well as the use of a material for the magnetic actuator.

2. Description of the Related Art

From the related art, magnetic actuators are known for the actuation of valves, for example, solenoid injectors which are generally made from turned parts. To achieve a good force action on the magnet armature and the valve needle when a current is supplied to the solenoid coil, the magnetic flux in this case must be selectively restricted in order to guide it across the armature, the working air gap and the internal pole. In one variant, the restriction is achieved in a magnetic return path element by reducing the wall thickness section by section (geometric restriction). This diminishes the volume by which a high magnetic induction or saturation occurs, thereby reducing the stored energy. At the same time, however, the compressive strength and the mechanical strength of the component are reduced during the assembly process. In another variant, welding non-magnetic wall sections into the return path element produces a magnetic separation. In this case, it is a particular disadvantage that the manufacture or processing is very time-consuming and costly. In addition, an undefined material condition occurs in the heat input zone during welding of the return path element.

### BRIEF SUMMARY OF THE INVENTION

By having a simplified structure, the magnetic actuator according to the present invention makes it possible to achieve a significant reduction in material and manufacturing costs at a comparable dynamic performance (build-up and reduction of force). These advantages are achieved by a magnetic actuator including: a coil, an internal pole, an armature and a magnetic return path system, the magnetic return path system having a magnetic return path element made from a material having a two-phase structure.

In addition, the magnetic return path system preferably has a magnetic return path element made from a material having a two-phase structure including ferritic and austenitic components, or has austenitic and martensitic components which are formed by a deformation of austenitic components. Thus, the two-phase structure makes it possible to achieve a homogeneous and effective magnetic separation or restriction effect in the magnetic return path system of the actuator.

In a preferred embodiment, it is provided that the magnetic return path element is a one-piece component. This results in a further cost reduction by reducing the number of components. Furthermore, it is no longer necessary to have welds for joining individual components within the magnetic actuator, resulting in a simplified and more rapid manufacture.

In another preferred embodiment, it is provided that the magnetic return path element is a tubular sleeve. The design as a continuous tube enables geometric tolerances to be eliminated, for example, those of wall thicknesses, as disturbance variables of the magnetic restriction effect. This makes it possible to achieve a lower tolerance scattering of the magnetic properties of the components in mass production. Moreover, there is no need for manufacturing time-consuming and costly turned parts, thereby reducing the addition of material. The manufacture of the tubular sleeve by deformation results in a selective setting of the magnetic properties and material solidification at the same time.

Furthermore, it is preferred that the material including ferritic and austenitic components is a duplex steel. The use of duplex steel implements the magnetic restriction function with the aid of the lower saturation induction compared to conventional ferromagnetic materials. Due to the reduced saturation induction, larger and continuous wall thicknesses may be provided, which contribute to the increase in strength and durability. The duplex material is also significantly more cost-effective than, for example, a pure austenitic material.

In an advantageous embodiment, a component Y of the ferritic component lies between 25% and 75% and a component Z of the austenitic component amounts to Z=1−Y. It is also preferred that the ferritic and austenitic components are equal (50:50). Varying the material components thus makes it possible to precisely adjust the functional properties of the actuator according to the present invention by adapting different geometrical parameters of the magnetic circuit, such as, for example, cover thickness, base thickness, armature length or sleeve wall thickness to the magnetic properties of the used sleeve material.

Furthermore, the magnetic return path element preferably covers the internal pole in the axial direction and the armature at least partially in each case. This makes it possible for the coil to be sealed off from the fuel medium by the return path element, so that the demands on the material durability of the coil are significantly reduced, which contributes to further cost savings.

The present invention further includes a valve for injecting fuel or controlling a valve member including a magnetic actuator according to the present invention. The embodiments described in connection with the magnetic actuator according to the present invention are preferably used on the valve according to the present invention. It is advantageous in particular to use the valve for intake manifold injection or direct gasoline injection.

Furthermore, the present invention includes the use of a material having a two-phase structure in a magnetic return path system. The two-phase structure preferably includes ferritic and austenitic components or austenitic components and, for example, martensitic components created by deformation of austenitic components.

### BRIEF DESCRIPTION OF THE DRAWINGS

FIG. 1 shows a section through a magnetic actuator according to the present invention according to a preferred exemplary embodiment.

FIG. 2 shows a schematic view of an injector which includes the magnetic actuator according to the preferred exemplary embodiment of the present invention.

### DETAILED DESCRIPTION OF THE INVENTION

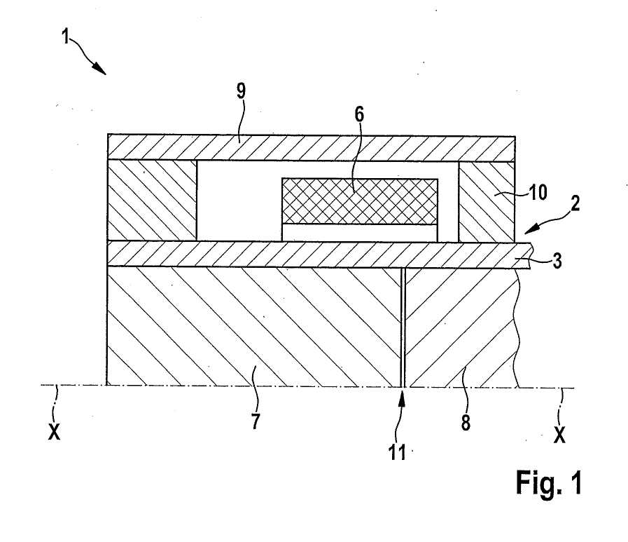

With reference to FIG. 1, a preferred exemplary embodiment of a magnetic actuator 1 is described in the following.

For the sake of clarity, FIG. 1 shows magnetic actuator 1 represented in a half section, including a magnetic return path system 2 having a tubular return path element 3 designed as a one-piece sleeve in axial direction X-X. A coil 6 is situated radially outside of return path element 3. Radially inside of return path element 3, an internal pole 7 rests on return element 3 which is stationary with respect to return path element 3. This internal pole 7 is adjoined by an armature 8. This armature 8 is movable in an axial direction X-X inside of return path element 3. A small armature gap 11 is situated between internal pole 7 and armature 8.

Furthermore, magnetic actuator 1 includes a housing 9, which is closed by a cover 10. Return path element 3, internal pole 7, armature 8, cover 10, housing 9, and coil 6 are designed to be cylindrical. The axial direction X-X forms the cylindrical center axis of all these components.

Cylindrical return path element 3 covers internal pole 7 in axial direction X-X and working gap 11 completely and armature 8 partially. Alternatively, return path element 3 may also have an axial length, which covers internal pole 7 only partially. Furthermore, return path element 3 covers coil 6 completely in axial direction X-X.

Return path element 3 is formed from a duplex steel having ferritic and austenitic components. The ferritic material component is preferably between 25% and 75%, the austenitic component having a complementary percentage in each case. Alternatively, a duplex steel having equal ferritic and austenitic components may be used. In addition, a duplex steel having austenitic and martensitic components may also be used, which is formed, for example, by a deformation of austenitic components.

The magnetic actuator according to the present invention is able to combine the advantages of a magnetic separation and a magnetic restriction by using one-piece return path element 3 made from a material having a two-phase structure. The selective matching of material and geometric properties makes it possible to have an improvement of the magnetic properties of the magnetic circuit and a resulting optimized valve function having increased dynamics at high internal pressure.

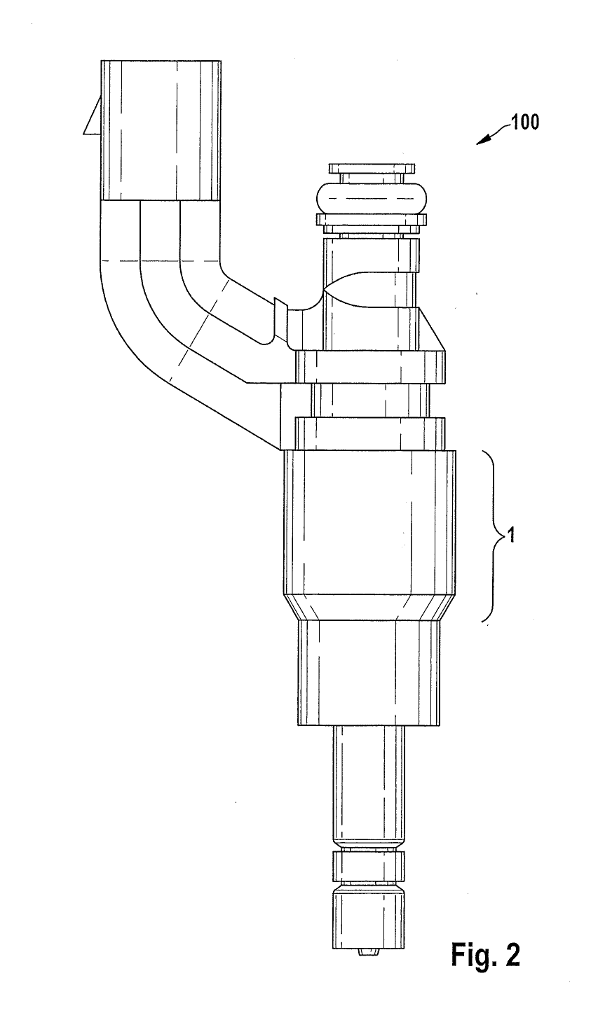

FIG. 2 shows such an injector 100. For the movement of armature 8, this injector 100 has a magnetic actuator according to the exemplary embodiment of the present invention shown in FIG. 1.

What is claimed is:

1. A magnetic actuator, comprising:
a coil;
an internal pole;
an armature; and
a magnetic return path system having a magnetic return path element made of a material having a two-phase structure.

2. The magnetic actuator as recited in claim 1, wherein one of: (i) the two-phase structure includes ferritic and austenitic components; or (ii) the two-phase structure includes austenitic and martensitic components which are formed by a deformation of austenitic components.

3. The magnetic actuator as recited in claim 2, wherein the magnetic return path element is a one-piece component.

4. The magnetic actuator as recited in claim 2, wherein the magnetic return path element is a tubular sleeve.

5. The magnetic actuator as recited in claim 2, wherein the material having the two-phase structure (i) includes ferritic and austenitic components, and (ii) is a duplex steel.

6. The magnetic actuator as recited in claim 5, wherein a proportion of the ferritic component in the two-phase structure is between 25% and 75%, and the austenitic component is the remainder of the two-phase structure.

7. The magnetic actuator as recited in claim 2, wherein the magnetic return path element at least partially covers the internal pole and the armature in the axial direction.

8. The magnetic actuator as recited in claim 2, wherein the magnetic actuator is part of a valve for injecting fuel.

9. A method of using a material having a two-phase structure in a magnetic return path system of a magnetic actuator, comprising:
providing a magnetic return path element of the magnetic return path system, wherein the magnetic return path element is made of the material having a two-phase structure, wherein one of: (i) the two-phase structure includes ferritic and austenitic components; or (ii) the two-phase structure includes austenitic and martensitic components which are formed by a deformation of austenitic components.
